(19) United States
(12) Patent Application Publication
(10) Pub. No.: US 2021/0249940 A1
(43) Pub. Date: Aug. 12, 2021

(54) DIRECT CURRENT POWER SUPPLY EXCITER MANAGEMENT

(71) Applicant: Hamilton Sundstrand Corporation, Charlotte, NC (US)

(72) Inventor: Kurt W. Duesterhoeft, Rockford, IL (US)

(21) Appl. No.: 16/788,952

(22) Filed: Feb. 12, 2020

(51) Int. Cl. H02K 19/26; H02P 25/16; H02P 9/30; H02K 21/04; H02M 7/12

(52) U.S. Cl. CPC H02K 19/26; H02P 25/16; H02P 2101/30; H02K 21/04; H02M 7/12; H02P 9/302

(57) ABSTRACT

Also disclosed is a method for exciting a generator of a direct current power supply with a controller. The method includes receiving a phase voltages associated with multiphase output of the generator. The method includes determining a maximum line-to-line voltage based on the phase voltages. The method includes operating an exciter winding driver with an oscillating signal generated according to the maximum line-to-line voltage.

### BACKGROUND

Aircraft often include power supplies for supplying electrical buses with electricity. Electrical buses may be supplied by rotating machines having exciters commonly integrated or within a common shaft to generate magnetic fields. Electrical buses may be designated to provide a particular voltage (e.g., 270). Aircraft electrical buses may operate any number of aircraft loads, including propulsion.

### BRIEF DESCRIPTION

In addition to one or more of the features described above, or as an alternative, further embodiments may include that

Disclosed is a direct current power supply. The direct current power supply includes an exciter having an excitation winding and operable to output an excitation voltage. The direct current power supply includes a generator connected to the exciter and that generates a multiphase output having phase voltages based on the excitation voltage. The direct current power supply a rectifier configured to receive the multiphase output and having diodes oriented to rectify multiphase output. The direct current power supply includes a direct current link capacitor connected to an output of the rectifier that generates a direct current link capacitor voltage. The direct current power supply includes a controller having an exciter winding driver, digital storage, and instructions stored on the digital storage. The instructions are operable upon execution by the controller to receive a phase voltage for each phase of the multiphase output. The instructions are operable upon execution by the controller to define a maximum line-to-line voltage based on the phase voltages. The instructions are operable upon execution by the controller to generate an oscillating signal according to the maximum line-to-line voltage. The instructions are operable upon execution by the controller to energize the exciter winding driver to drive the excitation winding based on the oscillating signal.

In addition to one or more of the features described above, or as an alternative, further embodiments may include that the multiphase output includes a first multiphase output, a second multiphase output, and a third multiphase output. In addition to one or more of the features described above, or as an alternative, further embodiments may include that the phase voltages comprise a first phase voltages with respect to a neutral reference, a second phase voltages with respect to the neutral reference, and a third phase voltages with respect to the neutral reference, respectively. In addition to one or more of the features described above, or as an alternative, further embodiments may include that the maximum line-to-line voltage is a maximum value of one of: the first phase voltages less the second phase voltages; the second phase voltages less the third phase voltages; or the third phase voltages less the first phase voltages.

In addition to one or more of the features described above, or as an alternative, further embodiments may include that the maximum line-to-line voltage is the maximum value less a diode constant.

In addition to one or more of the features described above, or as an alternative, further embodiments may include that the generator operates according to a generator cycle that is defined as one full electrical cycle of the generator, and the maximum line-to-line voltage is equal to each of the first phase voltages less the second phase voltages, the second phase voltages less the third phase voltages, and the third phase voltages less the first phase voltages once during the generator cycle.

In addition to one or more of the features described above, or as an alternative, further embodiments may include that the phase voltages defines a quadratic mean that is maintained greater than the direct current link capacitor voltage during a load-off.

Also disclosed is a direct current power supply having a controller. The direct current power supply includes digital storage. The direct current power supply includes instructions stored on the digital storage. The instructions are operable upon execution by the controller to receive a phase voltages associated with an multiphase output of a generator, define a maximum line-to-line voltage based on the phase voltages, and operate an exciter winding driver with an oscillating signal generated according to the maximum line-to-line voltage.

In addition to one or more of the features described above, or as an alternative, further embodiments may include that the multiphase output is a first multiphase output, a second multiphase output, and a third multiphase output. In addition to one or more of the features described above, or as an alternative, further embodiments may include that the phase voltages is a first phase voltages with respect to a neutral reference, a second phase voltages with respect to the neutral reference, and a third phase voltages with respect to the neutral reference, respectively.

In addition to one or more of the features described above, or as an alternative, further embodiments may include that the maximum line-to-line voltage is a maximum value of the first phase voltages less the second phase voltages, the second phase voltages less the third phase voltages, or the third phase voltages less the first phase voltages.

In addition to one or more of the features described above, or as an alternative, further embodiments may include that the maximum line-to-line voltage is the maximum value less a diode constant.

In addition to one or more of the features described above, or as an alternative, further embodiments may include a rectifier conductive with the multiphase output having diodes oriented to rectify the multiphase output. In addition to one or more of the features described above, or as an alternative, further embodiments may include a direct current link capacitor configured to provide a direct current link capacitor voltage from the rectifier based on the multiphase output.

In addition to one or more of the features described above, or as an alternative, further embodiments may include that the phase voltages define a quadratic mean that is maintained greater than the direct current link capacitor voltage during a load-off.

In addition to one or more of the features described above, or as an alternative, further embodiments may include that the maximum line-to-line voltage is equal to each of the first phase voltages less the second phase voltages, the second phase voltages less the third phase voltages, and the third phase voltages less the first phase voltages once during a generator cycle.

In addition to one or more of the features described above, or as an alternative, further embodiments may include an exciter having an excitation winding and defining an excitation voltage. In addition to one or more of the features described above, or as an alternative, further embodiments may include the generator operable to generate the multiphase output defining the phase voltages based on the excitation voltage.

Also disclosed is a method for exciting a generator of a direct current power supply with a controller. The method includes receiving a phase voltages associated with multiphase output of the generator. The method includes determining a maximum line-to-line voltage based on the phase voltages. The method includes operating an exciter winding driver with an oscillating signal generated according to the maximum line-to-line voltage.

In addition to one or more of the features described above, or as an alternative, further embodiments may include that the phase voltages is a first phase voltages with respect to a neutral reference, a second phase voltages with respect to the neutral reference, and a third phase voltages with respect to the neutral reference, and the maximum line-to-line voltage is a maximum value of the first phase voltages less the second phase voltages, the second phase voltages less the third phase voltages, or the third phase voltages less the first phase voltages.

In addition to one or more of the features described above, or as an alternative, further embodiments may include that the maximum line-to-line voltage is the maximum value less a diode constant.

In addition to one or more of the features described above, or as an alternative, further embodiments may include that the maximum line-to-line voltage is equal to each of the first phase voltages less the second phase voltages, the second phase voltages less the third phase voltages, and the third phase voltages less the first phase voltages once during a generator cycle.

In addition to one or more of the features described above, or as an alternative, further embodiments may include energizing an excitation winding associated with the exciter winding driver to excite the generator.

In addition to one or more of the features described above, or as an alternative, further embodiments may include that the phase voltages defines a quadratic mean that is maintained greater than a direct current link capacitor voltage during a load-off.

In addition to one or more of the features described above, or as an alternative, further embodiments may include that the oscillating signal defines a pulse width modulation signal having a duty cycle sized to maintain a direct current link capacitor at a voltage output setpoint.

### BRIEF DESCRIPTION OF THE DRAWINGS

The following descriptions should not be considered limiting in any way. With reference to the accompanying drawings:

FIG. 1 illustrates a direct current power supply in accordance with one or more implementations of the present disclosure;

FIG. 2 illustrates phase voltages of a generator in accordance with one or more implementations of the present disclosure; and

FIG. 3 illustrates a method for exciting a generator in accordance with one or more implementations of the present disclosure.

### DETAILED DESCRIPTION

A detailed description is provided herein. No attempt to claim or disclaim any subject matter present in this section is asserted, nor does Applicant disavow any implementations that omit, add, or otherwise alter the provided disclosure. It should be appreciated that any combinations of circuitry, electronics, or communications may be used. Any type of electric machine or generation means may be implemented.

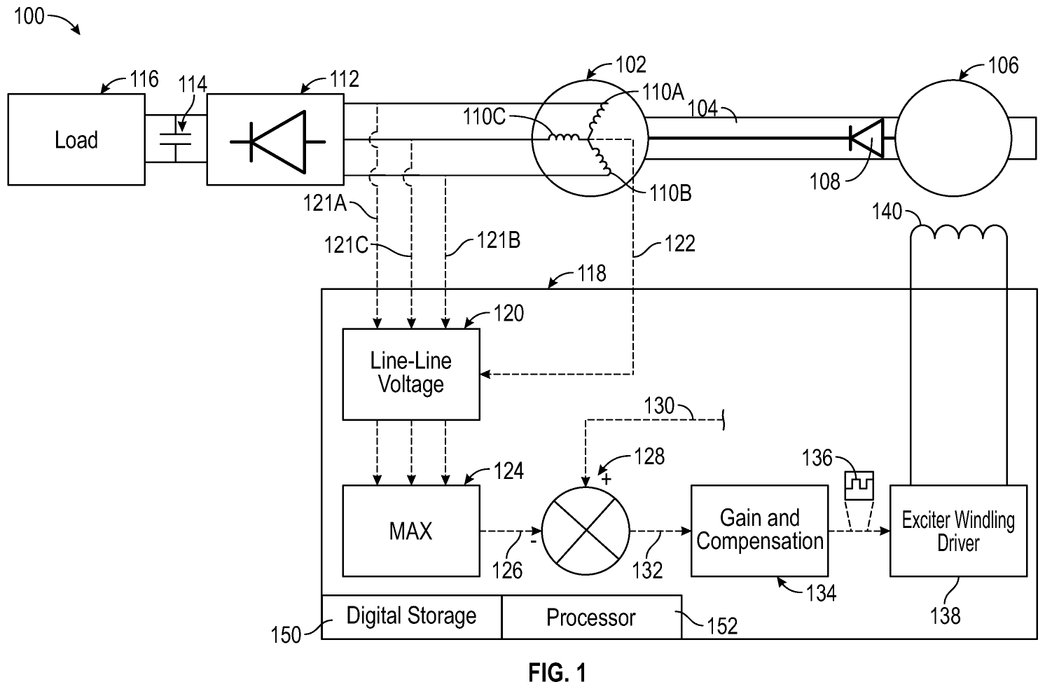

Referring to FIG. 1, a schematic diagram of a direct current power supply 100 is shown in accordance with one or more implementations of the present disclosure. The direct current power supply 100 includes an exciter 106. The exciter 106 is driven by one or more excitation windings 140. It should be appreciated that the excitation winding 140 may be unitarily disposed with the exciter 106 (e.g., stator). That is, excitation winding 140 may be the stator, and exciter 106 may be the rotor or portions thereof. The excitation windings 140 may be self-powered, auxiliary powered, or permanent magnet powered (not shown). The exciter 106 is disposed on a common shaft or rotor 104 with a generator 102. The exciter 106 output is rectified with excitation rectifier 108 to generate the rotating electric field on the rotor 104. The rectifier 112 may have diodes in a typical half-leg configuration for each of the multiphase outputs 110A, 110B, 110C to rectify the alternating current from the generator 102. The electric field drives multiphase outputs 110A, 110B, 110C from the generator 102. The multiphase outputs 110A, 110B, 110C are rectified with rectifier 112. A direct current link capacitor 114 is used to smooth the rectified output from rectifier 112 to supply a direct current link capacitor voltage (e.g., the voltage across the capacitor) to the load 116.

Phase voltages 121A, 121B, 121C may be measured from the multiphase outputs 110A, 110B, 110C, using any measurement implementation. It should be appreciated that a three-phase generator 102 is shown merely as an example and that any number of phases greater or less than three are contemplated in this disclosure. The phase voltages 121A, 121B, 121C may be determined with respect to ground or neutral 122. Although shown in a Wye configuration, the generator 102 may be wound in a Delta configuration. It should be appreciated that the multiphase outputs 110A, 110B, 110C may consist of only one output from the generator 102.

A controller 118 may be configured to receive the phase voltages 121A, 121B, 121C. The controller 118 may include any combination of processors, field programmable gate arrays (FPGA), or application specific integrated circuits (ASIC), collectively processors 152. The controller 118 may include digital storage 150, non-volatile, operable to store machine instructions from the processors and other processing mechanisms to receive, calculate, and control devices, as necessary. Machine instructions may be stored (e.g., stored instructions, stored machine instructions, stored steps) in any language or representation, including but not limited to machine code, assembly instructions, C, C++, C #, PYTHON. Communications may be realized through any protocol or medium. It should be appreciated that instructions may include any combination of circuitry, logic, memory, and/or machine code, to facilitate operation of the generator 102.

The controller 118 may have instructions operable upon execution by the processor 152 to determine a line-to-line voltage 120. The line-to-line voltage 120 may be defined as shown in equations 1-3.

|V_{AB}|−|V_{AN}−V_{BN}| (1)

|V_{BC}|=|V_{BN}−V_{CN}| (2)

|V_{CA}|−|V_{CN}−V_{AN}| (3),

where the V_{AN} is the phase voltage, which may be defined as a first phase voltage, between the phase voltage 121A and the neutral reference 122, where the V_{BN} is the phase voltage, which may be defined as a second phase voltage, between the phase voltage 121B and the neutral reference 122, where the V_{CN} is the phase voltage, which may be defined as a third phase voltage, between the phase voltages 121C and the neutral reference 122. It should be appreciated that the first, second, and third voltages may be interchanged or redefined (e.g., first phase voltage is defined as the second phase voltage). In the circumstance where the generator 102 only generates one multiphase output, the line-to-line voltage is the absolute value of the peak-to-peak voltage with respect to neutral.

As such, the line-to-line, or line-to-neutral, voltages (|V_{AB}|, |V_{BC}|, may be directly measured, received, or calculated by the controller 118. A maximum line-to-line voltage 126 may be determined by the controller 118 through maximum line-to-line instructions 124 stored on the digital storage 150. The maximum line-to-line instructions 124 may be determined by equation 4.

V_{DC}=MAX[|V_{AN}−V_{BN}|,|V_{BN}−V_{CN}|,|V_{CN}−V_{AN}|]−K_{DIODE} (4),

where V_{DC} is the expected output voltage of the direct current power supply 100 according to the maximum line-to-line voltage 126 based on phase voltages 121A, 121B, 121C. As such, the controller 118 can control the output voltage of the direct current power supply 100 without direct measurement. The maximum line-to-line voltage 126 may be offset or otherwise adjusted by a diode constant, K_{DIODE}. The diode constant may be measured or estimated based on the configuration or rating of the direct current power supply 100 or otherwise.

As shown, the controller 118 may include a feedback loop as indicated by summation block 128 and voltage output setpoint 130. The controller 118 may include gain and compensation instructions 134 to control the exciter winding driver 138. Gain and compensation instructions 134 may output an oscillating signal 136 to the exciter winding driver 138 using pulse width modulation hardware or other modulation hardware (e.g., analog outputs). It should be appreciated that the driver may be operable to receive digital instructions as well. The oscillating signal 136 may be a pulse width modulation signal. The pulse width modulation signal may have a duty cycle based on the desired excitation voltage of the generator 102 to result in the required direct current output at the direct current link capacitor 114. As an example, the voltage output setpoint 130 may be defined as the 270 volts. The duty cycle may be defined as the ratio between HIGH or TRUE and LOW or FALSE values of the oscillating signal 136. The exciter winding driver 138 may be of any type, including solid state circuitry operable to energize the exciter winding 140 to induce current in the exciter 106.

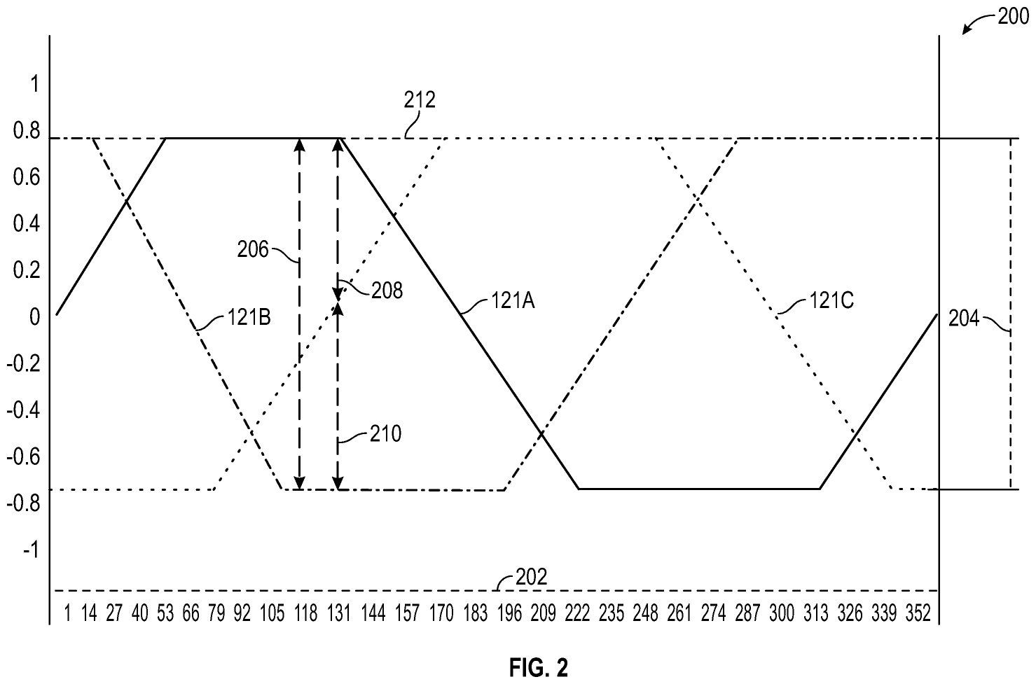

Referring to FIG. 2, phase voltages 121A, 121B, 121C are illustrated in accordance with one or more implementation of the present disclosure. A generator cycle 202 is shown, corresponding with one full electrical cycle 202 of the generator 102. A peak-to-peak voltage 204 is illustrated where the phase voltages 121A, 121B, 121C are clamped, indicating conduction of the rectifier 112 and voltage change resistance by the direct current link capacitor 114. Such clamping can limit the maximum voltage of the phase voltages 121A, 121B, 121C and enables a more accurate depiction of the direct current output voltage at the direct current link capacitor 114 by measurement of the phase voltages 121A, 121B, 121C. When the phase voltages 121A, 121B, 121C are clamped a direct current measurement to maintain the output voltage is redundant. Phase voltages 121A, 121B, 121C may become unclamped during very light loads, no-load, or off-load conditions (e.g., startup loads, transient loads, load-shedding). As an example, direct current load 116 may be a direct current bus of an aircraft supply various aircraft loads. As loads switch on and off, stored energy in the generator 102 is transferred to the direct current link capacitor 114. As a result, the rectifier 112 may become reverse biased and the multiphase outputs unclamped. The controller 118 may lower the excitation voltage to decrease the output voltage of the generator 102, placing the generator 102 in a potentially under-excited condition. In the under-excited condition, the generator 102 may be unable to respond quickly to subsequent load-on transients (e.g., large voltage drops during the transient). Instead of monitoring both the direct current output voltage at the direct current link capacitor 114 and the phase voltages 121A, 121B, 121C, requiring two or more sensing loops; peak-to-peak or line-to-line voltage may be used based on the phase voltages 121A, 121B, 121C being in a cut-off state. As such, the amount of sensing loops may be reduced.

As shown the line-to-line voltage |V_{AB}| 206 is based on the absolute value of the first phase voltage 121A, V_{AN}, less the second phase voltage 121B, V_{BN}; the line-to-line voltage |V_{BC}| 208 is based on the absolute value of the second phase voltage 121B, V_{BN}, less the third phase voltage 121C, V_{CN}; and the line-to-line voltage |V_{CA}| 210 is based on the absolute value of the third phase voltage 121C, V_{CN}, less the first phase voltage 121A, V_{AN}. Controlling the exciter winding driver 138 with the maximum value of these results in ensuring under-excitation is avoided during offload while maintaining the quadratic mean 212 or voltage output of the direct current link capacitor 114 during a load-off. This generator 102 control and direct current power supply 100 control reduces the sensing loop requirements without under-excitation.

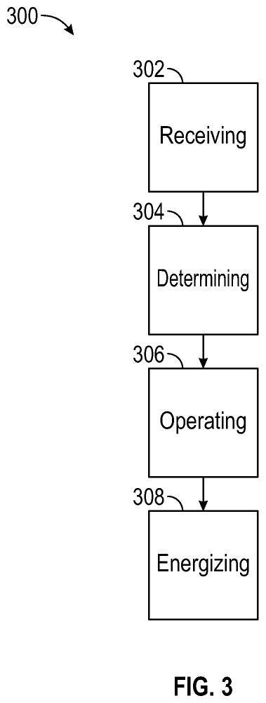

Referring to FIG. 3, a method 300 is shown. The method 300 may include additional steps or omit steps. The method 300 may include steps that may be performed sequentially or simultaneously. In step 302, the controller 118 receives phase voltages 121A, 121B, 121C. The phase voltages 121A, 121B, 121C may be received in any medium and by any mode. As a non-limiting example, the phase voltages 121A, 121B, 121C may be received as digital voltage values. As another, the phase voltages 121A, 121B, 121C may be received as direct or adjusted voltages directly from multiphase outputs 110A, 110B, 110C. A number of other implementations are contemplated in this disclosure.

In step 304, the controller 118 determines a maximum line-to-line voltage 126 (|V_{AB}|, |V_{BC}|, |V_{CA}|) based on the phase voltages 121A, 121B, 121C. Instructions may include a simple digital or analog comparator to determine the maximum line-to-line voltage 126. As such, the controller 118 is programmed to operate the exciter winding driver 138 in step 306. The operation may be based on any number of signals, including analog or digital signals. The operation may be based on an oscillating signal 136. The oscillating signal 136 may be a pulse width modulation signal having a duty cycle sized to maintain an operating voltage threshold of the direct current power supply 100. As such, the exciter winding driver 138 operates the excitation winding 140 to excite the generator 102, according to the maximum line-to-line voltage 126.

While the present disclosure has been described with reference to provided implements, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A direct current power supply that supplies power to a direct current load, the supply comprising:
an exciter having an excitation winding and operable to output an excitation voltage;
a generator connected to the exciter and that generates a multiphase output having phase voltages based on the excitation voltage;
a rectifier configured to receive the multiphase output and having diodes oriented to rectify multiphase output;
a direct current link capacitor connected to an output of the rectifier that generates a direct current link capacitor voltage;
a controller having an exciter winding driver, digital storage, and instructions stored on the digital storage operable upon execution by the controller to:
receive a phase voltage for each phase of the multiphase output;
define a maximum line-to-line voltage based on the phase voltages;
generate an oscillating signal according to the maximum line-to-line voltage; and
energize the exciter winding driver to drive the excitation winding based on the oscillating signal,
wherein the controller does not measure the output provided to the load by the direct current capacitor.

2. The direct current power supply of claim 1, wherein:
the multiphase output includes a first multiphase output, a second multiphase output, and a third multiphase output,
the phase voltages comprise a first phase voltages with respect to a neutral reference, a second phase voltages with respect to the neutral reference, and a third phase voltages with respect to the neutral reference, respectively, and
the maximum line-to-line voltage is a maximum value of one of: the first phase voltages less the second phase voltages; the second phase voltages less the third phase voltages; or the third phase voltages less the first phase voltages.

3. The direct current power supply of claim 2, wherein the maximum line-to-line voltage is the maximum value less a diode constant.

4. The direct current power supply of claim 2, wherein the generator operates according to a generator cycle that is defined as one full electrical cycle of the generator, and the maximum line-to-line voltage is equal to each of the first phase voltages less the second phase voltages, the second phase voltages less the third phase voltages, and the third phase voltages less the first phase voltages once during the generator cycle.

5. The direct current power supply of claim 1, wherein the phase voltages defines a quadratic mean that is maintained greater than the direct current link capacitor voltage during a load-off.

6.-13. (canceled)

14. A method for exciting a generator of a direct current power supply with a controller, comprising:
receiving a phase voltages associated with multiphase output of the generator;
determining a maximum line-to-line voltage based on the phase voltages;
operating an exciter winding driver with an oscillating signal generated according to the maximum line-to-line voltage,
wherein the controller is operated without measuring an output provided to a load by a direct current capacitor coupled to the load.

15. The method of claim 14, wherein the phase voltages is a first phase voltages with respect to a neutral reference, a second phase voltages with respect to the neutral reference, and a third phase voltages with respect to the neutral reference, and the maximum line-to-line voltage is a maximum value of the first phase voltages less the second phase voltages, the second phase voltages less the third phase voltages, or the third phase voltages less the first phase voltages.

16. The method of claim 15, wherein the maximum line-to-line voltage is the maximum value less a diode constant.

17. The method of claim 15, wherein the maximum line-to-line voltage is equal to each of the first phase voltages less the second phase voltages, the second phase voltages less the third phase voltages, and the third phase voltages less the first phase voltages once during a generator cycle.

18. The method of claim 15, further comprising energizing an excitation winding associated with the exciter winding driver to excite the generator.

19. The method of claim 14, wherein the phase voltages defines a quadratic mean that is maintained greater than a direct current link capacitor voltage during a load-off.

20. The method of claim 14, wherein the oscillating signal defines a pulse width modulation signal having a duty cycle sized to maintain a direct current link capacitor at a voltage output setpoint.
